(19) United States
(12) Patent Application Publication
(10) Pub. No.: US 2006/0010172 A1
(43) Pub. Date: Jan. 12, 2006

(54) System and method for generating text

(76) Inventors: Irene Grigoriadis, Malibu, CA (US); Shawn L.R. Brown, Tucson, AZ (US); Phillip Orona, Duarte, CA (US); Arthur R. Cortez, Covina, CA (US)

Correspondence Address: SHELDON & MAK, INC, 225 SOUTH LAKE AVENUE, 9TH FLOOR, PASADENA, CA, 91101, US

(21) Appl. No.: 10/887,162

(22) Filed: Jul. 7, 2004

(51) Int. Cl. G06F 12/00; G06F 17/30

(52) U.S. Cl. 707/200; 707/101

(57) ABSTRACT

A method for generating text relating to a product having a plurality of parts, the method comprising: receiving part information from a user; storing the received part information in a part information database; receiving part order information from the user, the part order information indicating the order that each part is disassembled from the product or assembled to form the product; storing the received part order in a part order database; and generating text from the part information database and the part order database.

### BACKGROUND

The present invention relates to a system and method for automatically generating text.

Typically, technical manuals accompany products. Technical manuals often explain how to operate, repair, test, assemble and disassemble a product in order to perform maintenance on the product. In some industries where products are highly regulated, such as in the airline industry, the products are often required to have detailed technical manuals conforming to predetermined standards.

Typically, technical manuals, and any text and figures contained within them, are generated by hand with the aid of computerized word processing systems and computerized drawing systems. Generating technical manuals by hand is an expensive, time consuming proposition. Additionally, with complex products, there is a potential for errors and inconsistencies.

There is therefore a need for an improved method for generating the content of documents, such as technical manuals, corresponding to a product.

### SUMMARY OF THE INVENTION

Accordingly, the present invention is directed to a method for generating text relating to a product having a plurality of parts. The method includes receiving part information from a user and storing the received part information in a part information database. The method also includes receiving part order information from the user, the part order information indicating the order that each part is disassembled from the product or assembled to form the product. The received part order information is stored in a part order database. Text is generated from the part information database and the part order database.

Optionally, the part information received from a user further includes a part identifier and a part description. The part order information received from the user can be separated into items, each item corresponding to a part used at a step in the disassembly or assembly of the product. Optionally, the part order information further comprises an item identifier corresponding to the assembly or disassembly order; an attaching part indicator for indicating whether the item is an attaching part; a part identifier corresponding to a part in the part information database; and a quantity of the item used in the product. Optionally, the part information and the part order information are stored in a single database.

In an embodiment of the present invention, the item numbers go from lowest to highest in order of disassembly from the product. The part order information received from a user for each item can also include an indenture level. Optionally, the product is a plurality of related products having common parts and the part order information received from a user for each item further comprises an effectivity indicator indicating which of the plurality of related products the item belongs to. An abbreviation database can also be accessed to convert abbreviations into words. The method for generating text can be used to generate one or more of: assembly instructions, disassembly instructions, a test procedure, a cleaning procedure, a repair procedure, an inspection procedure, and an operation procedure.

The present invention is also directed to a system for generating text relating to a product having a plurality of parts. The system comprises: a data processing system in communication with a mass storage device; a computer readable mass storage medium useable in the mass storage device, containing: a part information database and a part order database. The computer readable mass storage medium also contains instructions sufficient to cause the data processing system to generate text from the part information database and the part order database.

The present invention is also directed to a computer readable medium having contents for causing a computer-based information handling system to perform steps for generating text relating to a product having a plurality of parts. The steps comprise: receiving part information from a user; and storing the received part information into a part information database. The steps also comprise: receiving a part order from the user, the part order indicating the order that each part is disassembled from the product or assembled to form the product; and storing the received part order into a part order database. The steps also comprise: generating text from the part information database and the part order database.

### BRIEF DESCRIPTION OF THE DRAWINGS

A better understanding of the present invention will be had with reference to the accompanying drawings in which:

FIG. 1 is a flowchart describing an overview of a method of automatically generating text according to an embodiment of the present invention;

FIG. 2 is a schematic diagram of a computer system usable with the present invention;

FIG. 3 is a part information database usable with the present invention;

FIG. 4 is a part order database usable with the present invention;

FIG. 5 is a schematic diagram of a first portion of a method for text generation according to an embodiment of the present invention;

FIG. 6 is a schematic diagram of a second portion of a method for text generation according to an embodiment of the present invention; and

FIG. 7 is an abbreviation database usable with the present invention.

### DETAILED DESCRIPTION

Definitions

The term “product” as used herein refers to an object to be acted upon (e.g. assembled, disassembled, or operated) and that is the starting point for text generation. The product may in turn be a part of a larger product.

The term “part” as used herein refers to components of the product. A “part” does not have to be a physical piece, and includes software.

The term “text relating to a product” as used herein refers to text about a product such as, for example, assembly instructions, disassembly instructions, a test procedure, a cleaning procedure, a repair procedure, an inspection procedure, and an operation procedure.

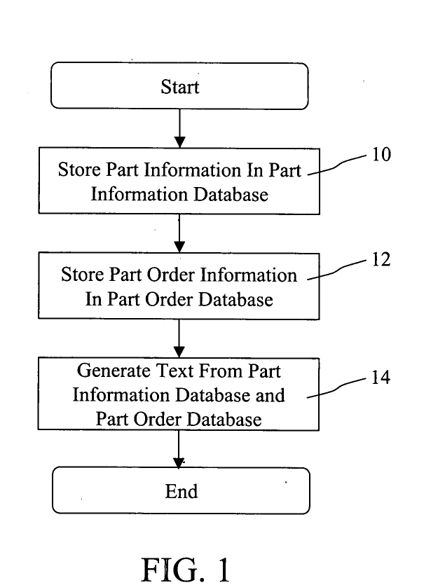

An overview of a computerized method for generating text relating to a product according to an embodiment of the present invention is shown in FIG. 1. Initially, information about the parts of a product is entered 10 into a part information database using a user computer system. Part order information, such as an assembly order or a disassembly order of the parts of the product, is entered 12 into a part order database using a user computer system. Text is generated 14 in reference to the part information database and the part order database. Once generated, the text can be formatted.

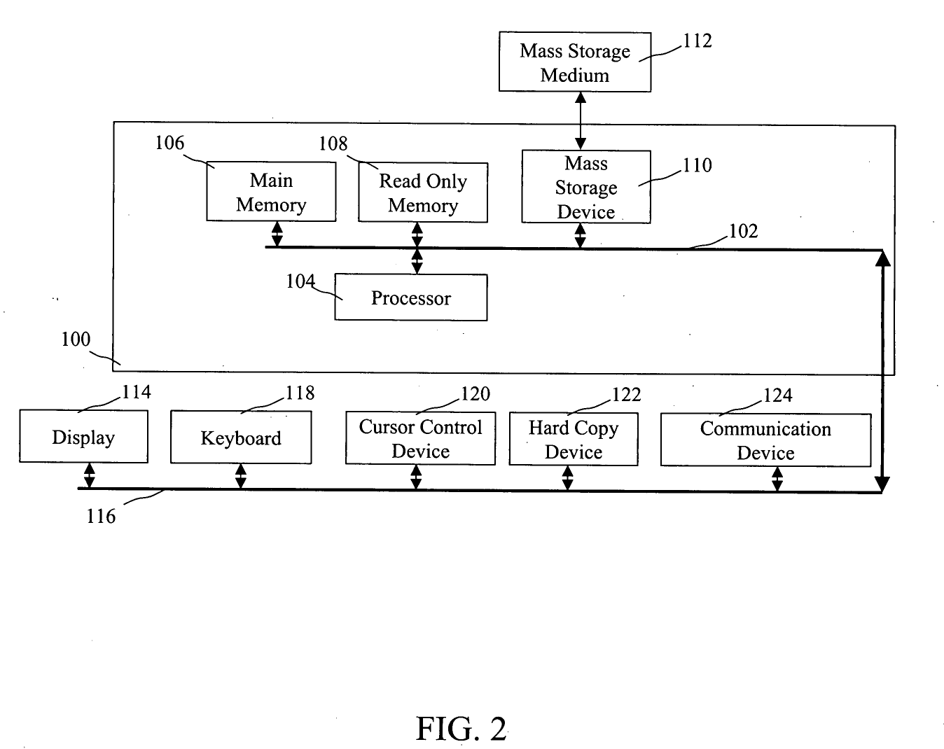

A computer system 100 usable as a user computer system is shown in FIG. 2. It will be apparent to those of ordinary skill in the art, however that additional system architectures may also be used. The computer system 100 illustrated in FIG. 2 includes a bus or other internal communication means 102 for communicating information, and a processor 104 coupled to the bus 102 for processing information and data.

The system further comprises a random access memory (RAM), or other volatile storage device 106 (referred to as main memory), coupled to bus 102 for storing information and instructions to be executed by the processor 104. The main memory 106 also may be used for storing temporary variables or other intermediate information during execution of instructions by the processor 104. The system also comprises a read only memory (ROM) and/or static storage device 108 coupled to bus 102 for storing static information and instructions for the processor 104, and a mass storage device 110 such as a magnetic disk drive or optical disk drive. The mass storage device 110 is coupled to bus 102 and is typically used with a computer readable mass storage medium 112, such as a magnetic or optical disk, for storage of information and instructions.

The system may further be coupled to a display device 114, such as a cathode ray tube (CRT) or a liquid crystal display (LCD) coupled to bus 102 through bus 116 for displaying information to a computer user. An alphanumeric input device 118, including alphanumeric and other keys, may also be coupled to bus 102 through bus 116 for communicating information and command selections to the processor 104. An additional user input device is a cursor control 120, such as a mouse, a trackball, stylus, or cursor direction keys coupled to bus 102 through bus 116 for communicating direction information and command selections to the processor 104, and for controlling cursor movement on the display device 114.

Another device which may optionally be coupled to bus 102 through bus 116 is a hard copy device 122 which may be used for printing instructions, data, or other information on a medium such as paper, film, or similar types of media. Optionally, a communication device 124 is coupled to bus 102 through bus 116 for use in accessing other nodes of a network computer system or other computer peripherals. The communication device 124 may include any of a number of commercially available networking peripheral devices such as those used for coupling to an Ethernet, token ring, Internet, or wide area network.

The communication device 124 may also include any number of commercially available peripheral devices designed to communicate with remote computer peripherals such as scanners, terminals, specialized printers, or audio input/output devices. The communication device 124 may also include an RS232 or other conventional serial port, a conventional parallel port, a small computer system interface (SCSI) port or other data communication means. The communications device 125 may use a wireless means of data transfer such as the infrared IRDA protocol, spread-spectrum, or wireless LAN.

Note that any or all of the components of the system illustrated in FIG. 2 and associated hardware may be used in various embodiments of the present invention; however, it will be appreciated by those of ordinary skill in the art that any configuration of the system may be used for various purposes according to the particular implementation. In one embodiment of the present invention, the system illustrated in FIG. 2 is an IBM® compatible personal computer (PC), an Apple Macintosh® personal computer, or a SUN® SPARC Workstation. The processor 104 may be one of the 80×86 compatible microprocessors such as the 80486 or PENTIUM® brand microprocessors manufactured by INTEL® Corporation of Santa Clara, Calif.

The software implementing the present invention can be stored in main memory 106, mass storage device 110, or another storage medium accessible to the processor 104. It will be apparent to those of ordinary skill in the art that the methods and processes described herein can be implemented as software stored in main memory 106 or read only memory 108 and executed by the processor 104. This software may also be resident on an article of manufacture comprising a computer usable mass storage medium 112 having computer readable program code embodied therein and being readable by the mass storage device 110 and for causing the processor 104 to perform digital information library transactions and protocols in accordance with the teachings herein.

Databases usable with the present system may be created using Microsoft Access® or Oracle Database Software®, or other software known in the art. The present invention utilizes databases to automatically generate text. It will be understood by those skilled in the art, that the elements listed as being in different cross-linked databases can be placed in a single database, and vice-versa. The method of the present invention may be performed over a network such as the Internet rather than via software and databases on a stand alone computer.

The operating system and computer programs are comprised of instructions which, when read and executed by the computer, cause the computer to perform the steps necessary to implement and/or use the present invention. Thus, the present invention may be implemented as a method, apparatus, system, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media, including the Internet.

Part Information

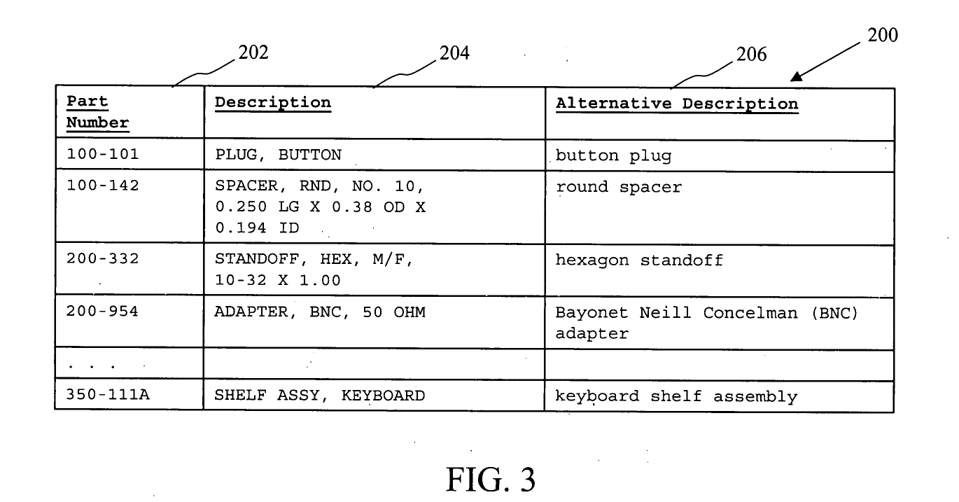

The input of part information will now be considered in more detail. FIG. 3 shows a portion of a part information database 200 for storing part information. Typically, the part information database includes a part identifier field 202 and a description field 204. The part identifier can be a part number. Optionally, the part information database includes an alternative description field 206 for storing an additional description that differs from the formal product description for insertion into some types of documents. Alternatively, an additional database table, called a nomenclature edit table may be used to store alternative descriptions for parts. Optionally, the part information database includes fields for additional information such as manufacturer part numbers.

The part information can be supplied in electronic format as part of an engineering drawing and a bill of materials from a manufacturer. Alternatively, some or all of the part information can be entered manually into the part information database by a user viewing an engineering drawing and bill of materials supplied from a manufacturer or by a user viewing a product.

Often families of products have sub-components and individual parts in common. Likewise, different versions of a product often employ common sub-components and parts. Therefore, in order to simplify the part entering process, a single database known as a “master part information database” is preferably constructed with each different part usable in a family of products. The use of a “master part information database” simplifies the part entry process for specific products. A user breaking down the part information of a product only has to enter cross-linking information, such as the part identifier, so that the detailed information can be accessed from the “master part information database” file without reentry.

Part Order Information

A user, with reference to either a product or a drawing, establishes a part order for the parts that make up the product. For example, the part order may constitute the disassembly order of parts that make up the product. Alternatively, the part order may constitute the assembly order of parts to make the product. An embodiment where the part order constitutes the disassembly order of the parts will now be described for the sake of example only.

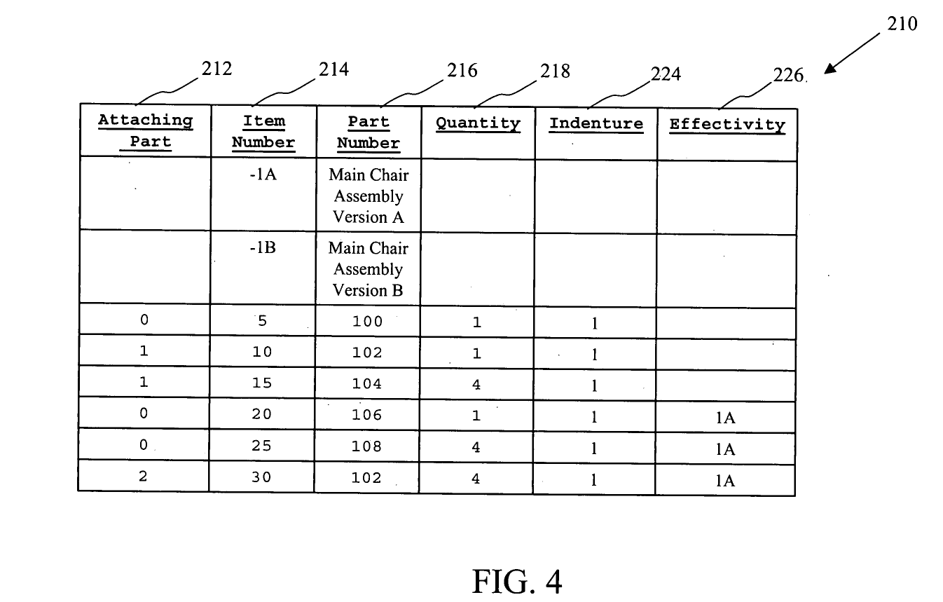

A user stores the disassembly order information in a part order database. A portion of a part order database 210 usable with the present invention is shown in FIG. 4. As shown in FIG. 4, the part order database 210 contains the following fields: an attaching part field 212, an item identifier field 214, a part identifier field 216 and a quantity field 218.

A user enters information about whether the item is an attaching part into the attaching part field 212. As used herein, the term “attaching part” means a part that attaches at least one part or the product itself to at least one other part. In an embodiment, the attaching part field 212 is a Boolean field with a yes or a no entry. As will be explained below, the text generator reviews the parts and determines that all the parts listed from the last previous attaching part are to be attached by all of the parts that are listed as attaching parts until the next non-attaching part.

Alternatively, as shown in FIG. 4, the attaching part field is a numerical quantity field. The user enters the number of parts attached by the attaching part. This clarifies for the text generator which previously listed non-attaching parts are attached by the attachment part.

The user enters an item identifier, such as an item number, into the item identifier field 214. The item identifier 214 indicates the part order. In the present example, the part order database is storing the disassembly order of the parts in a product in terms of item numbers. In the present example, the smaller the item number, the earlier in the disassembly process the part is removed from the product. Sequential item numbers may have gaps so that additional parts may be inserted without altering the order. Those skilled in the art will recognize that alternative indicators may be used to store the disassembly order. For example, a discrete number of disassembly steps may be determined, and a specific step number recorded with respect to each part of the product.

The user enters a part identifier in the part identifier field 216 to link with the part information database 200 for the additional information contained therein, such as the part description. Because the part order database references the part information database by part identifier, whether an item is an attaching part can be stored in the part order database instead.

Additionally, the quantity of the item required is stored in the quantity field 218. For example, if a plate is affixed to an assembly by four screws, the screws will be designated as an attaching part and assigned an item identifier. Additionally, the number four will be stored in the quantity field. Therefore, if a total of 100 screws are needed to attach various parts in the product, the screws will be assigned several different item identifiers, each having the same part identifier and each item number given a separate number in the quantity field. As part of a quality control process, the total number of each part identifier in the product may be verified against the total used with each different item identifier.

Optionally, the part order database contains an indenture field 224. The indenture field 224 is filled with a numerical value indicating the indenture level in any generated text document. The indenture level relates to how far down a subassembly is. For example, if part A can be broken down into parts B and C, then each of B and C are assigned a first level of indenture. If Part B can in turn be broken down into two parts E and F, then each of E and F are assigned a second level of indenture. The different levels of indenture are useful for formatting the generated text, and an indicator of indenture level may be required for certain types of technical documents. The higher the indenture level number, the lower in the assembly hierarchy the part is from the product. Additionally, for generating documents such as assembly instructions, the higher numbered indenture items may need to be assembled prior to their use in assembling the lower number indenture parts.

Optionally, the part order database contains an effectivity field 226. The effectivity field 226 is useful for constructing a single part order database for several products varying little from each other and utilizing many common parts. The user indicates which of the different products the part is relevant to in the effectivity field. Optionally, if the effectivity field is left blank, then the text generating software presumes that the part is used in all of the related products.

In order to track specific information about items contained in the database and the products or drawings to which the parts correspond, some records in the database can be used for the entry of special data. The text generator reviews records having a predetermined character entered in one of the fields for the special information. The predetermined character indicating special data may be, for example, a “−” preceding an item identifier. Optionally, identification information, such as a drawing number or product name, is entered into a record having the predetermined character. Optionally, in order to track revisions to the database, revision information is entered into a record having the predetermined character.

Often products are very similar, any differences constituting minor parts, leaving most assembly or disassembly instructions the same. Optionally, the additional products are designated with letters, such as itemA, itemB, and itemC. Specific information about each of the letter designated products is entered into the database in records in the database having the predetermined character. Optionally, additional replacement, superceded, or optional parts of the product may also be designated with letters, such as ItemA, itemB, and itemC. The different products may be referenced in the effectivity field 226 of specific parts as discussed above. Alternatively, an item usable with only one of the different products may have the letter of the product appended to its item identifier.

As will be understood by those skilled in the art, the part order database may cross reference the part information database for part information such as the description. Additionally, the part order database may be combined with the part information database in a single database, the single database being specific for a given product.

Text Generation

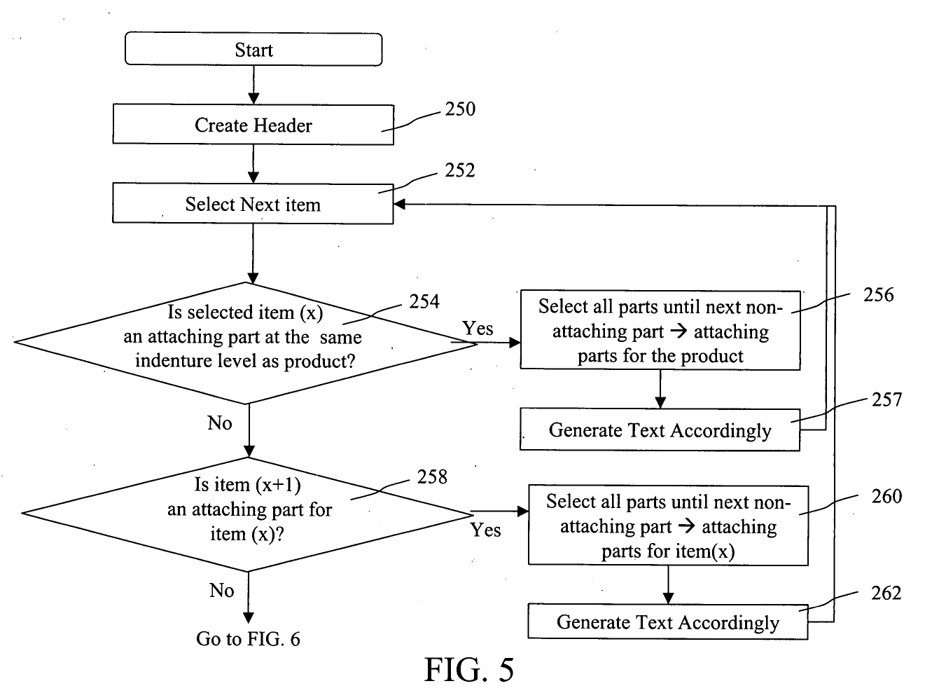

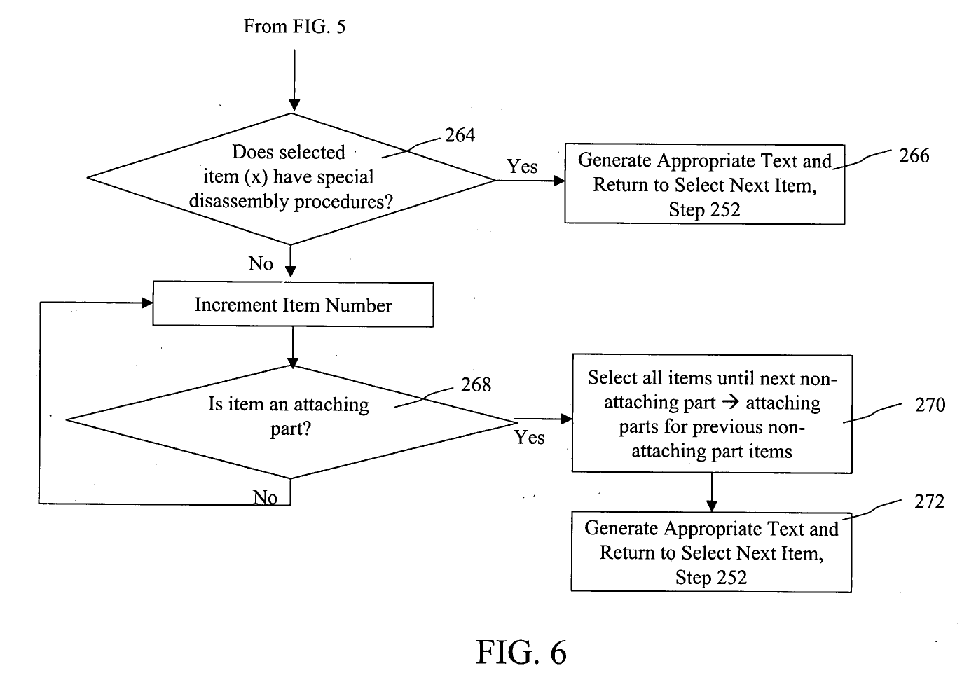

Text generation will now be discussed in the context of disassembly text generation with reference to FIGS. 5 and 6. For purposes of this example, the text generator is a software program installed on a computer, the software having access to the part information database 200 and the part order database 210.

Initially, a header is created in a header creation step 250. In order to generate the heading, the text generator looks for special records in the part order database containing the predetermined character. Once located, the special record is reviewed for a description of the product and any other relevant information such as a product number or drawing number listed in the record(s) to form the heading.

The text generator typically combines standard language with the heading information to generate a heading such as “Disassembly of the Product, Part identifier: Part Identifier”. As used herein, underlined portions of the text refer to variable information supplied from database records.

Optionally, the disassembly procedure is applicable to multiple similar products using some common parts, each product being referenced by a separate record containing the predetermined character. In this situation, the software generates a heading such as “Disassembly of the Products, Part Identifiers: Part Identifier 1A, and Part Identifier 1B.”

Once the heading is generated, the steps of the disassembly procedure are generated. Preferably, rules are used to produce grammatically correct full syntax structured sentences. For example, throughout the generation of the disassembly steps, the quantities of each part are considered. In the generated text, the letter “s” is placed at the end of appropriate words, and either “is” or “are” are placed prior to verbs where required so that the wording is correct. Additionally, for example, words to be pluralized that end in a “y” are changed to “ies”.

After generating the heading from the specially indicated part order database records, the text generator begins generating disassembly instructions. Proceeding sequentially in item number order, the text generator selects the next item. The item selected is considered to be item(x). The text generator checks to see if item(x) is an attaching part at the same indenture level as the product, step 254. If item(x) is an attaching part at the same indenture level as the product, then all of the subsequent items until an item not an attaching part are used to attach the product to some other object, step 256. Appropriate text is then generated, step 257. For example, “Remove the quantity item(x) part description(s), and the quantity item(x+1) part descriptions(s) that hold the product in position. Remove the product.”

If item(x) is not an attachment part, then the text generator looks at the next item, item(x+1) and determines whether item(x+1) is an attaching part at the same indenture level as item(x), step 258. As shown in FIG. 5, if item (x+1) is an attaching part at the same indenture level as item(x), then all of the subsequent items until an item not an attaching part are used to attach item(x). The text generator then selects all of the subsequent items until an item not an attaching part in step 260. The text generator then generates appropriate text in step 262, such as “Remove the quantity item(x+1) part description(s), and the quantity item(x+2) part description(s) that hold the item(x) part description in position. Remove the item(x) part description.”

Optionally, the description of item(x) can be used to further customize the generated text. For example, the text generator can check to see if item(x) is a cable assembly or a harness assembly. If item(x) is a cable assembly generate the following text: “Remove the quantity item(x+1) part description(s), and the quantity item(x+2) part description(s) that hold the item(x) part description cable assembly in position. Disconnect and remove the item(x) part description cable assembly.”

Optionally, the nature of the attaching parts can be checked to further customize the generated text. For example, check to see if item(x+1) is bonded. If item(x+1) is bonded, the text generator can then attach a note after the instruction, such as “Item(x) part description is/are held in place with bonding compound as well as item(x+1) part description and item(x+2) part description.”

If item (x+1) is not an attaching part, then check item(x) to see if the item has special disassembly procedures, step 264, as shown in FIG. 6. For example, the item(x) part description may be searched for text indicating that item(x) is a bonded item. If item(x) is a bonded item, then subsequent items are searched to see if they are bonded items. Depending on the special disassembly procedures required, appropriate text is generated in step 266. After finding the last bonded item, the text generator checks the leading noun in the descriptions of all of the bonded items. If the leading noun is the same, then appropriate text may be generated such as “The item(x) product description are/is a bonded item(s) and are not removed. Replace only as necessary.” If the leading noun is not the same, then appropriate text may be generated such as “The item(x) product description, the item(x+1) product description, and the item(x+2) product description(s) are/is a bonded item(s) and is/are not removed. Replace only as necessary.”

For example, the item(x) part description may be searched for text indicating that item(x) is a strap, cable, or wire tie. If item(x) is a strap cable, cable or wire tie, then subsequent items are searched to see if they are straps cables or wire ties. After finding the last strap, cable or wire tie, the text generator checks the leading noun in the descriptions of all of the strap, cables and wire ties. If the leading noun is the same, then appropriate text may be generated such as “Remove the ground straps item(x) reference number, item(x+1) reference number, item(x+2) reference number).” If the leading noun is not the same, then appropriate text may be generated such as “Remove the ground straps item(x) reference number, item(x+1) reference number, item(x+2) reference number), cable tie item(x+3) reference number, and wire ties item(x+4)reference number, item(x+5) reference number).”

If item(x) and item(x+1) are not attaching parts, then each subsequent item is checked until an attaching part is found, step 268. All of the items from the first attaching part until the next non-attaching part are used to attach the quantity of previous parts indicated in the attaching part field 212 or all of the items prior to the first attaching part if the attaching part field is Yes or No, and those items are all selected in step 270. Appropriate text is then generated in step 272. For example, “Remove the attaching part item quantities, descriptions and other information that hold(s) the non-attaching part item quantities, descriptions and other information in position. Remove the non-attaching part item quantities, descriptions and other information.”

Once the attaching parts are used to generate text, then the next non-attaching part becomes item(x) and the process is repeated. Optionally, when the text generator determines that an item is the last item or the last item at an indenture level, the text generator generates special text, such as “the last item(x) product description.”

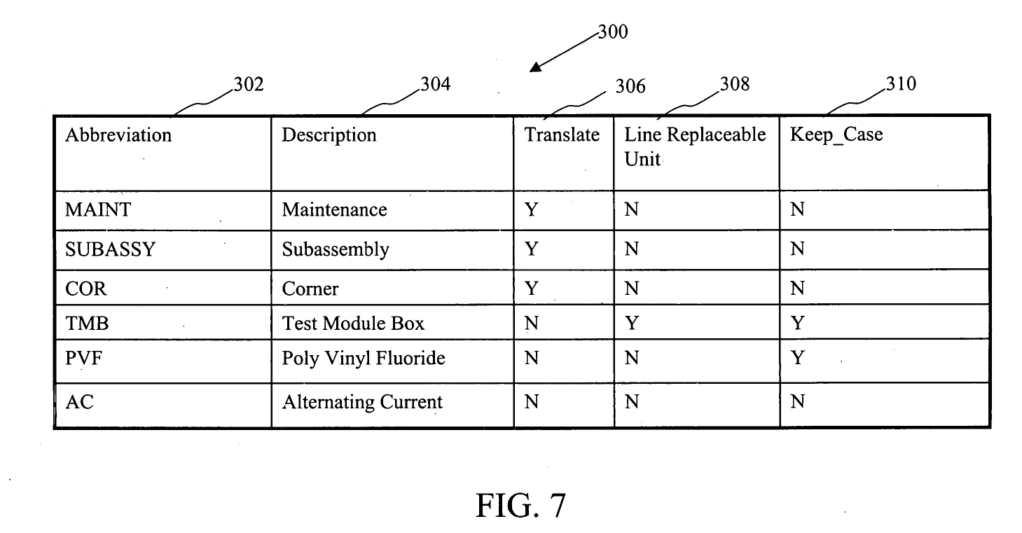

Optionally, an abbreviation database 300 is used to help generate the text. The abbreviation database 300 is used, for example, to expand the language contained in the product description and part descriptions. An example abbreviation database 300 is shown in FIG. 7. The abbreviation database 300 may contain the following fields: an abbreviation field 302, a description field 304, a translate field 306, a line replaceable unit field 308, and a keep case field 310.

The abbreviation field 302 contains the abbreviation to be converted into a different form. The description field 304 contains the converted form of the abbreviation. The translate field 306 is optionally used to ensure that certain abbreviations are not translated. For example, if an N is placed in this field, then the abbreviation is not translated. This field is used for abbreviations such as AC which need to be left unchanged in the text. The ability to change the value in the translate field allows for a given abbreviation to be translated in some, but not all generated text.

The line replaceable unit field 308 is used to indicate that the item is converted once, and after that the abbreviation is used. The keep case field 310 indicates that the converted text keeps the case that is used in the description field rather than converting the case to, for example, initial caps. For example, USA should be translated as “United States of America”.

Optionally, a translate once field may be added to the abbreviation database. The translate once field is similar to the line replaceable unit field, except that the number of translations per document is set to a different parameter, such as once per chapter.

The text generator formats the text based on the indenture level. Optionally, a format table specifies the formatting characteristics for each indenture level. Optionally, the text generator numbers each separate disassembly step.

It will be understood by those skilled in the art that the logic above may be reversed in order to generate disassembly instructions from a part order database where the items are numbered in order of assembly. After creating the heading, the text generator selects highest number items first and works backward toward the lowest number items.

Additional Types of Text

The text generator can also be used to generate assembly instructions. The process for creating the header is the same as the process discussed above with regard to the disassembly header with appropriate assembly language substituted into the header. In order to generate the assembly instructions using a part order database in disassembly order, the logic discussed above with regard to disassembly is essentially reversed starting at the highest numbered items and working toward the lowest numbered items.

Alternatively, in order to generate assembly instructions, the process may utilize a part order database where the items are numbered in order of assembly. The text generator follows the logic of the disassembly example set forth above and generates text appropriate for assembly instructions, substituting words such as “connect” for “disconnect” and “attach” for “remove”.

To generate text for additional procedures, additional databases may be used and assembly and disassembly instructions may be generated. For example, in order to generate a test procedure, a separate test database is constructed indicating what item or items must be accessed in order to perform a test and a test description about what the test entails. The disassembly procedure described above is used to generate text for disassembling the product to get to the item(s) to be accessed. The test description is then used to generate text about what to do with the accessed item(s). Assembly procedure text is then generated from the point of the accessed item(s) back to the overall product.

For example, in order to generate a cleaning procedure, a separate cleaning procedure database is constructed indicating what item or items must be accessed in order to perform the cleaning and a cleaning description about what the cleaning entails. The disassembly procedure described above is used to generate text for disassembling the product to get to the item(s) to be accessed. The cleaning description is then used to generate text about how to clean the accessed item(s). Assembly procedure text is then generated from the point of the accessed item(s) back to the overall product.

For example, in order to generate a repair procedure, a separate repair procedure database is constructed indicating what item or items must be accessed in order to complete the repair and a repair description about what the repair entails. The disassembly procedure described above is used to generate text for disassembling the product to get to the item(s) to be repaired. The repair description is then used to generate text about how to repair the accessed item(s). Assembly procedure text is then generated from-the point of the accessed item(s) back to the overall product.

The repair procedure generated may be designed to replace one or more parts. Here, disassembly instructions are generated to the point of removal of the part to be replaced farthest down on the disassembly order. Assembly instructions are then generated, including the new part(s) to be used as replacement(s).

For example, in order to generate an inspection procedure, a separate inspection procedure database is constructed indicating what item or items must be accessed in order to perform the inspection and an inspection description about what the inspection entails with regard to the accessed item(s). The disassembly procedure described above is used to generate text for disassembling the product to get to the item(s) to be inspected. The inspection description is then used to generate text about how to inspect the accessed item(s). It is foreseeable, that the inspection procedure will require further disassembly and inspection depending on the results of the inspection. Assembly procedure text is then generated from the point of the last disassembled item(s) back to the overall product.

For example, in order to generate an operation procedure, a separate operation procedure database is constructed indicating what item or items must be accessed in order to perform an operation and an operation description about the operation to be performed on the now accessible item. The disassembly procedure described above is used to generate text for disassembling the product to get to the item to be accessed. The operation details are then used to generate text about how to operate the accessed item. Assembly procedure text is then generated from the point of the accessed item(s) back to the overall product.

Optionally, the above testing, cleaning, repair, inspection, operation, databases can be combined in a single procedure database. The procedure database can contain a procedure type field for storing a procedure type. The procedure database can also contain a procedure item field for storing the number of the item or items that must be accessed to complete the procedure. Additionally, the procedure database contains a procedure description text field for storing a description of the procedure to be performed.

Alternatively, the procedure database contains an item type which can be used to generate procedure text for all parts of a given type. For example, in order to generate text for cleaning all rubber parts, the item type may store the word “rubber”, and the part description corresponding to each item number may be searched for the word “rubber”. Once all of the rubber parts are located, disassembly instructions are generated to reach each rubber part, cleaning instructions are generated from text in the procedure description text field, and assembly instructions are generated to reassemble the product.

Although the present invention has been described in considerable detail with-reference to certain preferred versions thereof, other versions are possible. Therefore, the spirit and scope of the appended claims should not be limited to the description of the preferred versions described herein.

All features disclosed in the specification, including the claims, abstract, and drawings, and all the steps in any method or process disclosed, may be combined in any combination except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

What is claimed is:

1) A method for generating text relating to a product having a plurality of parts, the method comprising:
receiving part information from a user;
storing the received part information in a part information database;
receiving part order information from the user, the part order information indicating the order that each part is disassembled from the product or assembled to form the product;
storing the received part order information in a part order database; and
generating text from the part information database and the part order database.

2) The method for generating text of claim 1 wherein the part information received from a user further comprises:
a part identifier; and
a part description;
wherein the part order information received from the user is separated into items, each item corresponding to a part used at a step in the disassembly or assembly of the product, and wherein the part order information further comprises:
an item identifier corresponding to the assembly or disassembly order;
an attaching part indicator for indicating whether the item is an attaching part;
a part identifier corresponding to a part in the part information database; and
a quantity of the item used in the product.

3) The method for generating text of claim 2 wherein the item identifier is a number and the item numbers go from lowest to highest in order of disassembly from the product.

4) The method for generating text of claim 2 wherein the attaching part indicator indicates the quantity of other items attached by the item.

5) The method for generating text of claim 2 wherein the part order information received from a user for each item further comprises an indenture level.

6) The method for generating text of claim 2 wherein the product is a plurality of related products having common parts and wherein the part order information received from a user for each item further comprises an effectivity indicator indicating which of the plurality of related products the item belongs to.

7) The method for generating text of claim 2 wherein converting part information further comprises accessing an abbreviation database for converting abbreviations into words.

8) The method for generating text of claim 1 wherein the generated text is assembly instructions.

9) The method for generating text of claim 1 wherein the generated text is disassembly instructions.

10) The method for generating text of claim 1 further comprising:
receiving procedure information from the user;
storing the received procedure information in a procedure information database;
wherein the generated text is generated from the part information database, the part order database, and the procedure database; and
wherein the generated text is one of the group consisting of a test procedure, a cleaning procedure, a repair procedure, an inspection procedure, and an operation procedure.

11) A system for generating text relating to a product having a plurality of parts, the system comprising:
a data processing system in communication with a mass storage device;
a computer readable mass storage medium useable in the mass storage device, containing:
a part information database;
a part order database; and
instructions sufficient to cause the data processing system to generate text from the part information database and the part order database.

12) The system for generating text of claim 11 wherein the part information database comprising:
a part identifier field; and
a part description field; and
wherein the part order database stores information about a plurality of items, each item corresponding to a part used at a step in the disassembly or assembly of the product, the part order database comprising:
an attaching part indicator field for indicating whether the item is an attaching part;
an item identifier field for containing an item identifier corresponding to an assembly order or a disassembly order;
a part identifier field for containing a part identifier corresponding to a part in the part information database; and
a quantity field for containing a quantity of the item present in the object.

13) The system for generating text of claim 12 wherein the order database is constructed in a disassembly order of the parts of the product; wherein the item identifier is a number and wherein the item numbers go from lowest to highest in order of disassembly.

14) The system for generating text of claim 12 wherein the attaching part indicator indicates the quantity of items attached by the item.

15) The system for generating text of claim 12 wherein the part order database further comprises an indenture level field for containing an indenture level.

16) The system for generating text of claim 12 wherein the system generates text for a plurality of products having common parts and wherein the part order database further comprises an effectivity indicator field for containing an effectivity indicator indicating which of the plurality of products the item belongs to.

17) The system for generating text of claim 12 further comprising an abbreviation database, the abbreviation being used by the data processing system to convert abbreviations into words.

18) The system for generating text of claim 12 wherein the generated text is assembly instructions.

19) The system for generating text of claim 12 wherein the generated text is disassembly instructions.

20) The system for generating text of claim 12 wherein the mass storage device further contains a procedure database;
wherein the instructions cause the data processing means to generate text from the part information database, the part order database, and the procedure database; and
wherein the generated text is one of the group consisting of: a test procedure, a cleaning procedure, a repair procedure, an inspection procedure, and an operation procedure.

21) A computerized method for generating text relating to a product having a plurality of parts, the method comprising:
storing part information in a part information database;
storing a part disassembly order in a part order database;
storing a plurality of abbreviations and corresponding text into an abbreviation database; and
generating disassembly instructions from the part information database, the part order database and the abbreviation database.

22) The method of claim 21 wherein the part order database further comprises heading information in records containing a predetermined character, the heading information including a description of the product; and wherein generating disassembly instructions further comprises generating a heading from a record in the part order database having the predetermined character.

23) A method for generating disassembly instructions relating to a product having a plurality of parts, the method comprising:
storing part information in a part information database;
storing a part disassembly order in a part order database;
storing a plurality of abbreviations and corresponding text into an abbreviation database; and
generating assembly instructions from the part information database, the part order database, and the abbreviation database;
wherein the part information saved includes whether the part is an attaching part;
wherein the part disassembly order comprises item numbers corresponding to the order of disassembly, each item number referencing a part number and having an indenture level.

24) A computer readable medium having contents for causing a computer-based information handling system to perform steps for generating text relating to a product having a plurality of parts, the steps comprising:
receiving part information from a user;
storing the received part information in a part information database;
receiving a part order from the user, the part order indicating the order that each part is disassembled from the product or assembled to form the product;
storing the received part order in a part order database; and
generating text from the part information database and the part order database.

25) The computer readable medium of claim 24 wherein the part information received from a user further comprises:
a part identifier; and
a part description; and
wherein the part order information received from the user is separated into items, each item corresponding to a part used at a step in the disassembly or assembly of the product, and wherein the part order information further comprises:
an item identifier corresponding to the assembly order or the disassembly order;
an attaching part indicator for indicating whether the item is an attaching part;
a part identifier corresponding to a part in the part information database; and
a quantity of the item used in the product.

26) A method for generating text relating to a product having a plurality of parts, the method comprising:
receiving part information from a user;
storing the received part information in a database;
receiving part order information from the user, the part order information indicating the order that each part is disassembled from the product or assembled to form the product;
storing the received part order information in the database; and
generating text relating to the product from the database.
